(19) United States
(12) Patent Application Publication
(10) Pub. No.: US 2023/0194659 A1
(43) Pub. Date: Jun. 22, 2023

(54) TARGET-BASED SENSOR CALIBRATION

(71) Applicant: GM Cruise Holdings LLC, San Francisco, CA (US)

(72) Inventor: Zhizhong Yan, SAN FRANCISCO, CA (US)

(21) Appl. No.: 17/559,627

(22) Filed: Dec. 22, 2021

(51) Int. Cl. G01S 7/40; G01S 13/931

(52) U.S. Cl. CPC G01S 7/40; G01S 13/931

(57) ABSTRACT

The subject disclosure relates to techniques for sensor calibration based on determining a curvature of a surface of a target. A process of the disclosed technology can include steps of receiving sensor data captured by the two or more sensors, wherein the sensor data includes multiple views of one or more targets in a scene, identifying the one or more targets based on the sensor data, and determining a curvature of a surface of each of the one or more targets based on the sensor data. The process can further include performing a calibration of the two or more sensors based on the curvature of the surface of each of the one or more targets in the sensor data. Systems and machine-readable media are also provided.

### TECHNICAL FIELD

The subject matter of this disclosure relates in general to the field of sensor systems, and more particularly, to solutions for a sensor calibration based on determining a curvature of a target.

### BACKGROUND

Autonomous vehicles (AVs) are vehicles having computers and control systems that perform driving and navigation tasks that are conventionally performed by a human driver. As AV technologies continue to advance, a real-world simulation for AV testing has been critical in improving the safety and efficiency of AV driving. An exemplary AV can include various sensors, such as a camera sensor, a Light Detection and Ranging (LiDAR) sensor, and a Radio Detection and Ranging (RADAR) sensor, among others.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1 illustrates an example sensor calibration environment according to some aspects of the disclosed technology.

FIGS. 2A and 2B illustrate example sensor calibration targets according to some aspects of the disclosed technology.

FIG. 3 is a flowchart of an example method for determining a curvature of a sensor calibration target, according to some aspects of the disclosed technology.

FIG. 4 illustrates an example AV environment including a computing system in communication with an AV, in accordance with some examples.

FIG. 5 shows an example of a computing system for implementing certain aspects of the present technology.

### SUMMARY

Disclosed are systems, apparatuses, methods, computer-readable medium, and circuits for determining a curvature of a target for sensor calibration. According to at least one example, a method includes receiving sensor data captured by the two or more sensors, wherein the sensor data includes multiple views of one or more targets in a scene, identifying the one or more targets based on the sensor data, and determining a curvature of a surface of each of the one or more targets based on the sensor data.

In some examples, the method further includes performing a calibration of the two or more sensors based on the curvature of the surface of each of the one or more targets in the sensor data. In some instances, the calibration of the two or more sensors comprises identifying at least one of an intrinsic parameter of the two or more sensors, an extrinsic parameter of the two or more sensors, and a shape of the one or more targets.

In some examples, the determination of the curvature of each of the one or more targets includes selecting at least three points on the surface of each of the one or more targets in the sensor data, determining a distance between the at least three points based on the sensor data, and comparing the distance between the at least three points based on the sensor data with a predetermined distance between corresponding points on a physical surface of each of the one or more targets. In some instances, the at least three points are corner points of each of the one or more targets.

In some examples, a relative position between the two or more sensors is constant. Furthermore, in some instances, the sensor data are captured by the two or more sensors simultaneously.

In another example, a system for a sensor calibration based on determining a curvature of a target includes two or more sensors, a storage (e.g., a memory configured to store data, such as virtual content data, one or more images, etc.), and one or more processors (e.g., implemented in circuitry) coupled to the memory and configured to execute instructions and, in conjunction with various components (e.g., a network interface, a display, an output device, etc.), cause the system to receive sensor data captured by the two or more sensors, wherein the sensor data includes multiple views of one or more targets in a scene, identify the one or more targets based on the sensor data, and determine a curvature of a surface of each of the one or more targets based on the sensor data.

A non-transitory computer-readable storage medium having stored therein instructions which, when executed by one or more processors, can cause the one or more processors to receive sensor data captured by the two or more sensors, wherein the sensor data includes multiple views of one or more targets in a scene, identify the one or more targets based on the sensor data, and determine a curvature of a surface of each of the one or more targets based on the sensor data.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for the convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

AVs utilize many sensors to navigate. Sensors typically capture data and provide measurements that do not necessarily account for the sensors' intrinsic parameters (e.g., focal length, optical center, skew, etc.) and extrinsic parameters (e.g., position and orientation). If sensors are not properly calibrated to account for those intrinsic or extrinsic parameters, AVs may not detect and/or may incorrectly detect object locations, which may create dangerous situations. Thus, calibration for these sensors is important for the operation of AVs.

A conventional sensor calibration approach involves capturing sensor data of a target, for example, a checkerboard-patterned target. These conventional calibration approaches utilizes the geometry of the target to calibrate the sensor with an assumption that the target is flat. However, target shapes can be prone to distortion, for example, due to environmental changes (e.g., fluctuations in temperature, pressure, or humidity, etc.) that may cause the target to warp to some degree and lead to an inaccurate calibration. An environmentally stable and perfectly flat target is not only costly but also almost impractical.

Aspects of the disclosed technology address the foregoing limitations by providing solutions for performing sensor calibration without the need to use flat (or nearly flat) calibration targets. More specifically, the sensor calibration based on determining a curvature of a surface of the target and therefore providing solutions for a sensor calibration that accounts for intrinsic and extrinsic parameters of the sensor. In some implementations, aspects of the disclosed technology provide a sensor calibration mechanism based on a target that is not necessarily flat or rather warped to a certain degree.

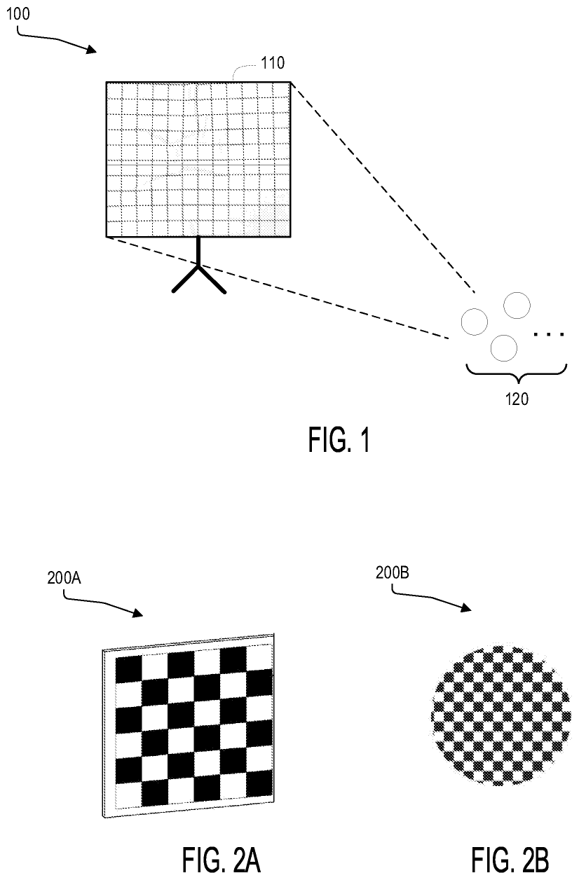

FIG. 1 illustrates an example sensor calibration environment 100, according to some aspects of the disclosed technology. As shown in FIG. 1, calibration environment 100 comprises a target 110 and multiple sensors 120 that capture sensor data corresponding with target 110. Examples of sensors 120 may include but are not limited to, camera, Light Detection and Ranging (LiDAR), radar, or any applicable sensor that may capture sensor data of target 110.

In some cases, target 110 may be slightly or significantly warped, which may cause distortions in sensor data collected for target 110, e.g., by sensors 120. In some instances, the curvature or distortion of target 110 may be due to environmental factors, such as changes in temperature, humidity, and/or pressure, etc. For example, target 110 may slightly shrink due to a temperature drop. The sensor data captured before and after the temperature drop may be conflicting even though the same target 110 is captured by the same sensors 120.

Even though FIG. 1 shows one target, any applicable number of targets can be used similarly. For example, sensors 120 may capture sensor data representing or corresponding with multiple targets. Based on extra data from multiple targets, more accurate calibration can be achieved.

FIGS. 2A and 2B illustrate example sensor calibration targets with patterns 200A and 200B according to some aspects of the disclosed technology. Example rectangular target 200A has a checkerboard pattern. Example circular target 200B has a grid pattern. The checkerboard or grid pattern of the target can provide spacing or distance information between any given points on target 200A or 200B. In some instances, such spacing or distance information can help detect any distortion or curvature for target 110. For example, the distance between two points on a portion of a non-flat surface of target 100 may be shorter than the distance measured on a perfectly flat surface of target 100. As such, the difference between these two distances can help detect a target curvature.

While only checkerboard or grid patterns are depicted with respect to FIGS. 2A and 2B, other patterns can additionally or alternatively be used in a similar fashion. For example, any pattern (e.g., crosshatched, lattice, etc.) that can provide spacing information between any selected points within the target can be used. Also, other applicable shapes of target may also be possible, for example, a triangular shape, a square, etc.

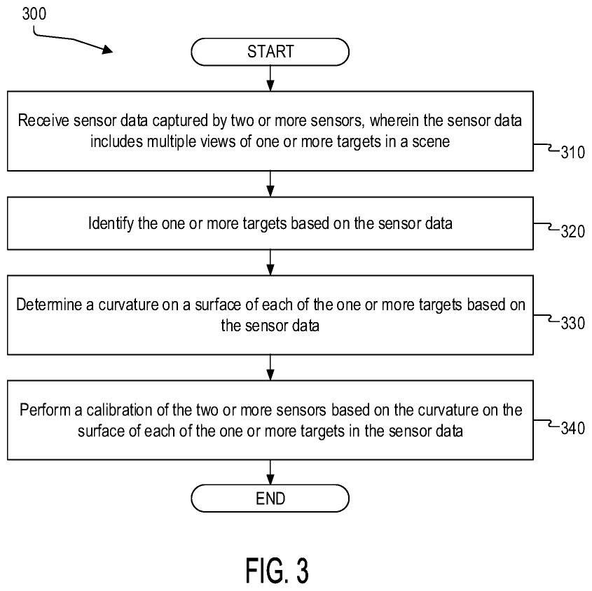

FIG. 3 is a flowchart of an example method 300 for determining a curvature of a target for a sensor calibration according to some aspects of the disclosed technology. Although example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements the method 300 may perform functions at substantially the same time or in a specific sequence.

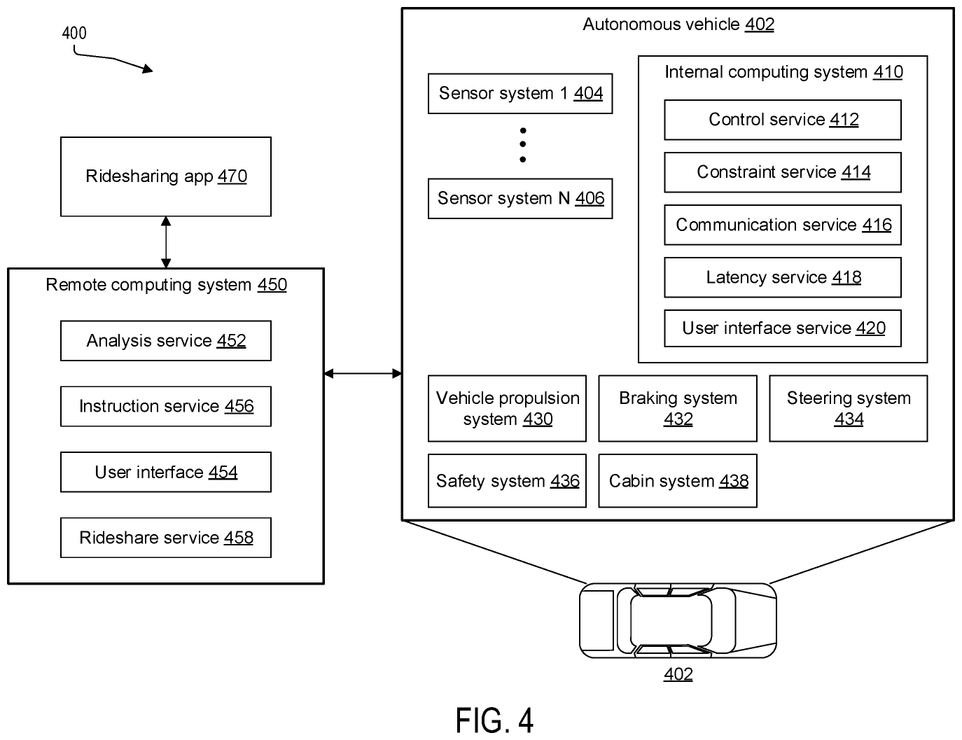

According to some examples, method 300 includes receiving sensor data captured by two or more sensors, wherein the sensor data includes multiple views of one or more targets in a scene at step 310. For example, computing system 410 as illustrated in FIG. 4 may receive sensor data captured by two or more sensors 120 as depicted in FIG. 1 or sensor systems 404-406 as illustrated in FIG. 4. Also, the sensor data may include multiple views of target 110 as illustrated in FIG. 1.

In some instances, a relative position between the two or more sensors is constant. For example, sensors 120 as illustrated in FIG. 1 can be affixed or coupled to a mounting plate or an autonomous vehicle such that the relative position between any two of sensors 120 remains constant and does not change when sensors 120 capture the sensor data of target 110. The relative position can be determined based on the distance and orientation (i.e., pose) of the sensors.

In some examples, when the sensors (e.g., sensors 120 in FIG. 1) are capturing the sensor data in multiple views of the target(s) (e.g., target 110 in FIG. 1), the distance between the target(s) and the sensors and orientation of the target(s) and the sensors may remain the same. The known distance between the target(s) and the sensors can be used in determining a curvature of the surface of the target(s) based on the sensor data at step 330, which is discussed in further detail below. Also, the orientation of the target(s) and the sensors may be pre-determined to help determine the curvature of the surface of the target(s).

In some instances, the distance between the target(s) and the sensors may be varied and modified to provide various views of the target so that intrinsic and extrinsic parameters of the sensors can be accounted for (e.g., data based on the various views can be compared for determining the curvature). For example, various views in the collection of sensor data may provide a representation of target(s) in various positions, rotations, and so forth so that intrinsic parameters (e.g., focal length, optical center, skew, etc.) and/or extrinsic parameters (e.g., position and orientation) may be identified for the sensor calibration. In some instances, multiple sensors can be calibrated with respect to one another to account for the differences in each of the sensors' intrinsic and extrinsic parameters.

In some examples, each of the sensors (e.g., sensors 120 illustrated in FIG. 1) may capture the sensor data of the target(s) (e.g., target 110 illustrated in FIG. 1) simultaneously or at different times. When the sensor data are captured by the two or more sensors simultaneously, multiple sensor data of the target may be free of or less affected by any possible environmental change during the capturing, which may lead to conflicting sensor data and inaccurate sensor calibration.

According to some examples, method 300 includes identifying the one or more targets in the scene based on the sensor data at step 320. For example, computing system 410 as illustrated in FIG. 4 may identify or determine a representation of target 110 as illustrated in FIG. 1 in the scene based on the sensor data, which is captured by sensors 120 in FIG. 1.

According to some examples, method 300 includes determining a curvature (i.e., any distortion) on a surface of each of the one or more targets based on the sensor data at step 330. For example, computing system 410 as illustrated in FIG. 4 may determine a curvature of the surface of target 110 as illustrated in FIG. 1 based on the sensor data.

In some examples, the determination of the curvature of the surface of each of the one or more targets includes selecting at least three points on the surface of each of the one or more targets in the sensor data and determining a distance between any two of the at least three points based on the sensor data. For example, computing system 410 in FIG. 4 may select three or more points on the surface of target 110 in FIG. 1 in the sensor data, which is captured by sensors 102 in FIG. 1. Further, computing system 410 may determine the distances between any two of the three or more points based on the sensor data.

In some instances, the three or more points can be corner points of the target(s). When the three points are located the farthest from each other, more surface area of the target(s), which may include a portion of any distortions of the target(s) can be considered. Further, the determination of the curvature of the surface of each of the one or more targets includes comparing the distance between the at least three points based on the sensor data with a predetermined distance between corresponding points on a physical surface of each of the one or more targets.

In some examples, the distance between three or more points on the target in the sensor data can be compared with corresponding distance calculated based on the pattern or grid of the same target.

In some examples, the distance between corresponding points on the physical surface of the target can be determined based on the pattern (e.g., checkerboard, grid, crosshatched, lattice, etc.) of the target(s). For example, an image recognition system running on a computer system (e.g., internal computing system 410 as illustrated in FIG. 4) may identify the checkerboard or grid pattern of FIGS. 2A and 2B and may determine the distance between any given points on the physical surface of target 110 as illustrated in FIG. 1.

In some examples, the distance between three or more points based on the sensor data of the target(s) can be compared with the predetermined distance between corresponding points determined based on the grid of the target(s). Any difference between these two distances can indicate a degree of curvature of distortion of the target(s).

In some instances, a two-dimensional plane (i.e., in x and y coordinates) can be formed by connecting the three points selected within the target(s) and a corresponding plane can be also formed based on the corresponding three points on the physical surface of the target(s). By comparing these two planes in x and y coordinates, z-component (i.e. depth information) can be determined. The depth information then can provide a degree of curvatures or distortions of the surface of the target(s).

As previously described, the known distance can be also used in determining a curvature of the surface of sensors based on the sensor data to provide a more accurate measurement of the distance between the selected points on the target(s).

According to some examples, method 300 includes performing a calibration of the two or more sensors based on the curvature of the surface of each of the one or more targets in the sensor data at step 340. For example, computing system 410 as illustrated in FIG. 4 may perform a calibration of sensors 120 depicted in FIG. 1 based on the curvature of the surface of target 110 in FIG. 1 in the sensor data.

In some instances, the calibration of the two or more sensors includes identifying at least one of an intrinsic parameter of the two or more sensors, an extrinsic parameter of the two or more sensors, and a shape of the one or more targets. For example, intrinsic parameters may include (e.g., focal length, optical center, skew, etc.) and extrinsic parameters may include (e.g., position and orientation). As previously discussed, multiple sensors can be calibrated with respect to one another to account for the differences in each of the sensors' intrinsic and extrinsic parameters and the shape of the target(s).

FIG. 4 illustrates environment 400 that includes an autonomous vehicle 402 in communication with a computing system 450.

The autonomous vehicle 402 can navigate about roadways without a human driver based upon sensor signals output by sensor systems 404-406 of the autonomous vehicle 402. The autonomous vehicle 402 includes a plurality of sensor systems 404-406 (a first sensor system 404 through an Nth sensor system 406). The sensor systems 404-406 are of different types and are arranged about the autonomous vehicle 402. For example, the first sensor system 404 may be a camera sensor system and the Nth sensor system 406 may be a lidar sensor system. Other exemplary sensor systems include radar sensor systems, global positioning system (GPS) sensor systems, inertial measurement units (IMU), infrared sensor systems, laser sensor systems, sonar sensor systems, and the like.

The autonomous vehicle 402 further includes several mechanical systems that are used to effectuate appropriate motion of the autonomous vehicle 402. For instance, the mechanical systems can include but are not limited to, a vehicle propulsion system 430, a braking system 432, and a steering system 434. The vehicle propulsion system 430 may include an electric motor, an internal combustion engine, or both. The braking system 432 can include an engine brake, brake pads, actuators, and/or any other suitable componentry that is configured to assist in decelerating the autonomous vehicle 402. The steering system 434 includes suitable componentry that is configured to control the direction of movement of the autonomous vehicle 402 during navigation.

The autonomous vehicle 402 further includes a safety system 436 that can include various lights and signal indicators, parking brake, airbags, etc. The autonomous vehicle 402 further includes a cabin system 438 that can include cabin temperature control systems, in-cabin entertainment systems, etc.

The autonomous vehicle 402 additionally comprises an internal computing system 410 that is in communication with the sensor systems 404-406 and the mechanical systems 430, 432, 434. The internal computing system includes at least one processor and at least one memory having computer-executable instructions that are executed by the processor. The computer-executable instructions can make up one or more services responsible for controlling the autonomous vehicle 402, communicating with remote computing system 450, receiving inputs from passengers or human co-pilots, logging metrics regarding data collected by sensor systems 404-406 and human co-pilots, etc.

The internal computing system 410 can include a control service 412 that is configured to control operation of the vehicle propulsion system 430, the braking system 432, the steering system 434, the safety system 436, and the cabin system 438. The control service 412 receives sensor signals from the sensor systems 404-406 as well communicates with other services of the internal computing system 410 to effectuate operation of the autonomous vehicle 402. In some embodiments, control service 412 may carry out operations in concert one or more other systems of autonomous vehicle 402.

The internal computing system 410 can also include a constraint service 414 to facilitate safe propulsion of the autonomous vehicle 402. The constraint service 414 includes instructions for activating a constraint based on a rule-based restriction upon operation of the autonomous vehicle 402. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 412.

The internal computing system 410 can also include a communication service 416. The communication service can include both software and hardware elements for transmitting and receiving signals from/to the remote computing system 450. The communication service 416 is configured to transmit information wirelessly over a network, for example, through an antenna array that provides personal cellular (long-term evolution (LTE), 3G, 5G, etc.) communication.

In some embodiments, one or more services of the internal computing system 410 are configured to send and receive communications to remote computing system 450 for such reasons as reporting data for training and evaluating machine learning algorithms, requesting assistance from remoting computing system or a human operator via remote computing system, software service updates, ridesharing pickup and drop off instructions etc.

The internal computing system 410 can also include a latency service 418. The latency service 418 can utilize timestamps on communications to and from the remote computing system 450 to determine if a communication has been received from the remote computing system 450 in time to be useful. For example, when a service of the internal computing system 410 requests feedback from remote computing system 450 on a time-sensitive process, the latency service 418 can determine if a response was timely received from remote computing system 450 as information can quickly become too stale to be actionable. When the latency service 418 determines that a response has not been received within a threshold, the latency service 418 can enable other systems of autonomous vehicle 402 or a passenger to make necessary decisions or to provide the needed feedback.

The internal computing system 410 can also include a user interface service 420 that can communicate with cabin system 438 in order to provide information or receive information to a human co-pilot or human passenger. In some embodiments, a human co-pilot or human passenger may be required to evaluate and override a constraint from constraint service 414, or the human co-pilot or human passenger may wish to provide an instruction to the autonomous vehicle 402 regarding destinations, requested routes, or other requested operations.

As described above, the remote computing system 450 is configured to send/receive a signal from the autonomous vehicle 402 regarding reporting data for training and evaluating machine learning algorithms, requesting assistance from remoting computing system or a human operator via the remote computing system 450, software service updates, ridesharing pickup and drop off instructions, etc.

The remote computing system 450 includes an analysis service 452 that is configured to receive data from autonomous vehicle 402 and analyze the data to train or evaluate machine learning algorithms for operating the autonomous vehicle 402. The analysis service 452 can also perform analysis pertaining to data associated with one or more errors or constraints reported by autonomous vehicle 402.

The remote computing system 450 can also include a user interface service 454 configured to present metrics, video, pictures, sounds reported from the autonomous vehicle 402 to an operator of remote computing system 450. User interface service 454 can further receive input instructions from an operator that can be sent to the autonomous vehicle 402.

The remote computing system 450 can also include an instruction service 456 for sending instructions regarding the operation of the autonomous vehicle 402. For example, in response to an output of the analysis service 452 or user interface service 454, instruction service 456 can prepare instructions to one or more services of the autonomous vehicle 402 or a co-pilot or passenger of the autonomous vehicle 402.

The remote computing system 450 can also include a rideshare service 458 configured to interact with ridesharing applications 470 operating on (potential) passenger computing devices. The rideshare service 458 can receive requests to be picked up or dropped off from passenger ridesharing app 470 and can dispatch autonomous vehicle 402 for the trip. The rideshare service 458 can also act as an intermediary between the ridesharing app 470 and the autonomous vehicle wherein a passenger might provide instructions to the autonomous vehicle to 402 go around an obstacle, change routes, honk the horn, etc.

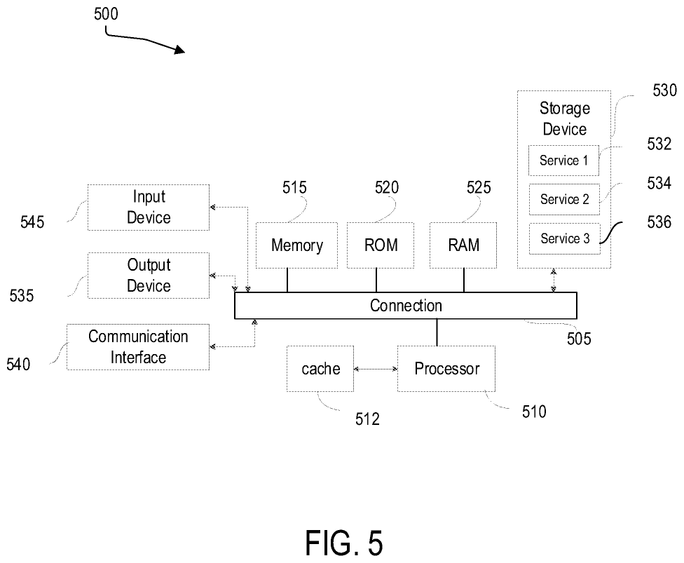

FIG. 5 shows an example of computing system 500, which can be for example any computing device making up computing system 410 as illustrated in FIG. 4, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions.

Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A sensor calibration system, comprising:
two or more sensors;
one or more processors coupled to the two or more sensors; and
a computer-readable medium comprising instructions stored therein, which when executed by the one or more processors, cause the one or more processors to:
receive sensor data captured by the two or more sensors, wherein the sensor data includes multiple views of one or more targets in a scene;
identify the one or more targets based on the sensor data; and
determine a curvature of a surface of each of the one or more targets based on the sensor data.

2. The sensor calibration system of claim 1, wherein the instructions, which when executed by the one or more processors, cause the one or more processors to:
perform a calibration of the two or more sensors based on the curvature of the surface of each of the one or more targets in the sensor data.

3. The sensor calibration system of claim 2, wherein the calibration of the two or more sensors comprises identifying at least one of an intrinsic parameter of the two or more sensors, an extrinsic parameter of the two or more sensors, and a shape of the one or more targets.

4. The sensor calibration system of claim 1, wherein the determination of the curvature of each of the one or more targets includes:
selecting at least three points on the surface of each of the one or more targets in the sensor data;
determining a distance between the at least three points based on the sensor data; and
comparing the distance between the at least three points based on the sensor data with a predetermined distance between corresponding points on a physical surface of each of the one or more targets.

5. The sensor calibration system of claim 4, wherein the at least three points are corner points of each of the one or more targets.

6. The sensor calibration system of claim 1, wherein a relative position between the two or more sensors is constant.

7. The sensor calibration system of claim 1, wherein the sensor data are captured by the two or more sensors simultaneously.

8. A method comprising:
receiving sensor data captured by two or more sensors, wherein the sensor data includes multiple views of one or more targets in a scene;
identifying the one or more targets based on the sensor data; and
determining a curvature of a surface of each of the one or more targets based on the sensor data.

9. The method of claim 8, further comprising:
performing a calibration of the two or more sensors based on the curvature of the surface of each of the one or more targets in the sensor data.

10. The method of claim 9, wherein the calibration of the two or more sensors comprises identifying at least one of an intrinsic parameter of the two or more sensors, an extrinsic parameter of the two or more sensors, and a shape of the one or more targets.

11. The method of claim 8, wherein the determination of the curvature of each of the one or more targets includes:
selecting at least three points on the surface of each of the one or more targets in the sensor data;
determining a distance between the at least three points based on the sensor data; and
comparing the distance between the at least three points based on the sensor data with a predetermined distance between corresponding points on a physical surface of each of the one or more targets.

12. The method of claim 11, wherein the at least three points are corner points of each of the one or more targets.

13. The method of claim 8, wherein a relative position between the two or more sensors is constant.

14. The method of claim 8, wherein the sensor data are captured by the two or more sensors simultaneously.

15. A non-transitory computer-readable storage medium comprising computer-readable instructions, which when executed by a computing system, cause the computing system to:
receive sensor data captured by two or more sensors, wherein the sensor data includes multiple views of one or more targets in a scene;
identify the one or more targets based on the sensor data; and
determine a curvature of a surface of each of the one or more targets based on the sensor data.

16. The non-transitory computer-readable storage medium of claim 15, wherein the instructions, which when executed by the computing system, further cause the computing system to:
perform a calibration of the two or more sensors based on the curvature of the surface of each of the one or more targets in the sensor data.

17. The non-transitory computer-readable storage medium of claim 16, wherein the calibration of the two or more sensors comprises identifying at least one of an intrinsic parameter of the two or more sensors, an extrinsic parameter of the two or more sensors, and a shape of the one or more targets.

18. The non-transitory computer-readable storage medium of claim 15, wherein the determination of the curvature of each of the one or more targets includes:
selecting at least three points on the surface of each of the one or more targets in the sensor data;
determining a distance between the at least three points based on the sensor data; and
comparing the distance between the at least three points based on the sensor data with a predetermined distance between corresponding points on a physical surface of each of the one or more targets.

19. The non-transitory computer-readable storage medium of claim 18, wherein the at least three points are corner points of each of the one or more targets.

20. The non-transitory computer-readable storage medium of claim 15, wherein a relative position between the two or more sensors is constant.
